(19) United States
(12) Patent Application Publication
(10) Pub. No.: US 2022/0172483 A1
(43) Pub. Date: Jun. 2, 2022

(54) SYSTEM AND METHOD SOCIAL DISTANCING RECOGNITION IN CCTV SURVEILLANCE IMAGERY

(71) Applicant: PatriotOne Technologies, Toronto (CA)

(72) Inventors: Cesar Augusto SUAREZ GARCIA, Saint John (CA); James Allan Douglas CAMERON, Saint John (CA); Phillip Konrad MUNZ, Saint John (CA)

(73) Assignee: PatriotOne Technologies, Toronto (CA)

(21) Appl. No.: 17/540,918

(22) Filed: Dec. 2, 2021

Related U.S. Application Data
(60) Provisional application No. 63/120,240, filed on Dec. 2, 2020.

(51) Int. Cl. G06V 20/52; G06V 20/40; G06V 20/70; G06T 7/70; G06N 20/00

(52) U.S. Cl. CPC G06V 20/53; G06V 20/40; G06N 20/00; G06T 7/70; G06V 20/70

(57) ABSTRACT

A system and method for more accurate recognition of adherence to social distancing regulations in image data. A curated dataset of surveillance footage is used that shows people at a variety of angles at a wide variety of distances. The videos of this dataset are annotated and a second, numeric dataset is created as input into various classical machine learning models. The trained model is tested on more annotated data and shows a noticeable improvement over the other attempted methods. The resulting analytics allows for accurate distinction between pairs of people that are at least 6 feet apart and pairs of people that are not. This method utilizes a random forest machine learning model to improve on the Euclidean method that measures distance between human detection centroids in the 2-dimensional target image.

### CROSS REFERENCE TO RELATED APPLICATIONS

The application claims priority to and the benefit of U.S. Provisional Patent Application Ser. No. 63/120240, entitled “SYSTEM AND METHOD SOCIAL DISTANCING RECOGNITION IN CCTV SURVEILLANCE IMAGERY”, filed on Dec. 2, 2020, the disclosure of which is incorporated herein by reference in its entirety.

### BACKGROUND

The embodiments described herein relate to security and surveillance, in particular, technologies related to video recognition threat detection.

In 2020, the World Health Organization declared the novel coronavirus (COVID-19) a pandemic. In the months following the declaration, strides were taken in an effort to slow the spread of this disease. One such method that has proven effective in achieving this is the concept of social (or physical) distancing. When practicing social distancing, two or more persons are attempting to decrease the risk of community transmission by keeping a minimum distance from each other at all times. This minimum distance is regulated by local authorities and subject to change, however most places agree that this safe distance starts at 2 m (6 ft).

While social distancing is an effective technique, it has the disadvantage that it is difficult to monitor for appropriate compliance. For example, in a room of only ten people, there are there are 10 choose 2 (10^{C2}) or 45 different pairs of people that could violate social distancing regulations. For many businesses it is not practical to have dedicated personnel monitoring a location to enforce social distancing and alleviate potential crowding due to a building's layout. As such, it is becoming a necessity to leverage technology to manage this new sanitary measure in crowded places.

The recent pandemic has generated much discussion and publication, some of which provide innovative solutions to monitoring social distancing violations. Many of these require pre-existing infrastructure in order to determine position and infer distances between people in an environment. One of the main technologies leveraged is a CCTV system, which is a network of surveillance cameras used to monitor a location. Through the use of modern computer vision algorithms, the location of people can be inferred in real-time, allowing the detection of social distancing violations to be automated.

Several publications have focused on imagery based social distancing recognition and have proven effective in certain scenarios. The work by Yang et al. showed that it was possible to provide social distancing alerts on surveillance style imagery through the use of calibration maps that are placed on the frame during system setup. Other publications have also implemented similar methods that require placing calibration points before the social distancing system can be deployed.

While calibration to a camera's field of view allows mapping the two dimensional image plane to a three dimensional space, thereby increasing the accuracy in distancing measurement, there are still some challenges with this approach. Primarily, cameras with a field of view that have multiple planes of movement (e.g. stairs) would require complex calibration phases, especially with locations with over 100 cameras. Additionally, cameras that move (e.g. PTZ cameras) would require constant calibration to remain effective.

It is desirable to use a machine learning approach to social distancing that requires no human intervention or scene calibration to reduce setup time and improve accuracy in complex scenes.

### SUMMARY

A system and method for more accurate recognition of adherence to social distancing regulations in image data. The system is implemented in a non-parameterized way, so it does not require manual input for different camera angles or scenes, nor does it require a calibration period.

A dataset of surveillance footage is curated. The dataset shows people at a variety of angles at a wide variety of distances. The videos of this dataset are annotated and a second, numeric dataset is created as input into a classical machine learning model. The trained model is tested on more annotated data and shows a noticeable improvement over the other attempted methods. The resulting analytics allows for accurate distinction between pairs of people that are at least 6 feet apart and pairs of people that are not. This method utilizes a random forest machine learning model and logistic regression classifier to improve on the Euclidean method that measures distance between human detection centroids in the 2-dimensional target image.

Social distancing is an effective technique to reduce the transmission of airborne illness. While this method is effective, it is difficult to enforce compliance. Several works have demonstrated the use of technology to monitor for social distancing violations, many using computer vision techniques utilizing surveillance cameras. This work presents a novel method for calibration-less social distancing recognition, providing quick and robust detection in different environments. With a custom dataset created solely for social distancing from 44 videos, multiple features were used to train machine learning algorithms that provide high accuracy detection while remaining computation.

### BRIEF DESCRIPTION OF THE DRAWINGS

FIG. 1 is a diagram illustrating two people with bounding boxes and centroids.

FIG. 2 is a graph illustrating results for classification and inference time.

FIG. 3A and 3B are diagrams illustrating examples of model outputs.

FIG. 4 is a block diagram illustrating an exemplary process or method for accurate recognition of adherence to social distancing regulations.

### DETAILED DESCRIPTION

In a preferred embodiment, a multi-sensor covert threat detection system is disclosed. This covert threat detection system utilizes software, artificial intelligence and integrated layers of diverse sensor technologies (i.e., cameras, etc.) to deter, detect and defend against active threats to health and human safety (i.e., detection of guns, knives or fights, or potential health and safety non-compliance) before these events occur.

It is desirable to use a machine learning approach to social distancing that requires no human intervention or scene calibration to reduce setup time and improve accuracy in complex scenes, such as those with two or more planes of perspective in the same frame. To train the algorithms, a dataset that uses positive and negative annotations of social distancing to approximate distance relationships in three dimensions. This data was cultivated from 44 multiple videos demonstrating an approach that is extensible across multiple potential surveillance camera angles. The preferred embodiment utilizes a single camera angle or static frames to test their social distancing recognition method. In further embodiments, more videos can be added to the dataset with a more purposeful eye towards identifying people standing at multiple distances from each other (e.g., 0 m to 5+ m) from different video sources (e.g., YouTube®, Tik Tok®, Facebook®, mobile phones, etc.).

### I. DATASET

### A. Imagery Source Criteria

To create our dataset, a collection of videos was taken that met the following criteria:
CCTV style camera quality and angle.
Includes pedestrian movement that would be a mix of people both infringing and adhering to social distancing norms
Scene composition and lighting conditions that was not already over-represented in our sample of videos.

### B. Annotation Process

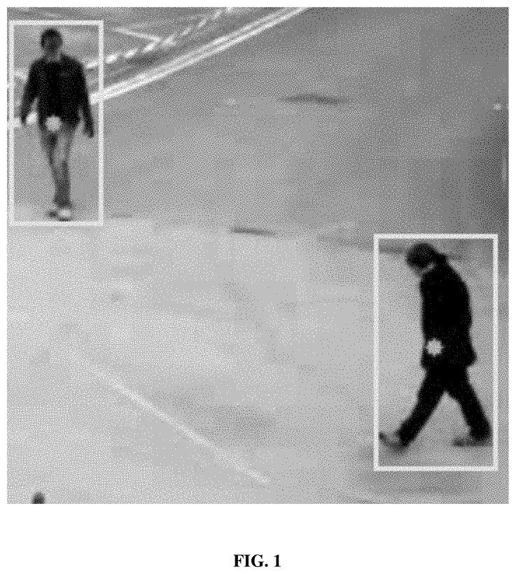

FIG. 1 is a diagram illustrating two people with bounding boxes and centroids. As seen in FIG. 1, each person in the frame with a bounding box is annotated. From here, each pair of people is annotated in the image as compliant or non-compliant with regards to their distance from one another. A full annotation consisted of the two bounding boxes of the people in question, as well as an accompanying binary response representing social distancing compliance.

For the response variable, 0 meant that the pair of people were not socially distancing enough, and 1 meant that they were. Subsequently, this information was saved to a CSV file. This process of inference and annotation was repeated for all videos, where every video had a separate CSV file. The resulting dataset contained over hundreds of thousands of points, of which roughly 25% were annotations of social distancing infractions were annotations of social distancing infractions (negative class) and the rest were of social distancing compliance (positive class). With this roughly 4-to-1 ratio, which characterized the dataset as imbalanced.

### II. METHODOLOGY AND SOCIAL DISTANCING ALGORITHMS

### A. System Definition

A social distancing recognition system is defined as the following two-part system:
Stage 1: The person detection.
Stage 2: The social distancing classifier.

### B. Person Detection

A strong first stage is a requirement to make a well-performing social distancing algorithm since the second stage of the pipeline entirely depends on the people detections created by Stage 1. Using the created annotations, one can be able to accurately identify where the pairs of people were in each frame to subsequently feed this information into a classifier during training and validation. However, at run time it is necessary to use an automated person detection to create the bounding boxes to be fed to the social distancing classifier.

Automated person detection can be achieved through a plethora of available pre-trained deep networks. Many of these pre-trained networks, such as Mask R-CNN, Faster RCNN and YOLO variants, have shown accurate, real-time performance on a variety of hardware. In general, the more accurate the model, the more computing power it will require to run in real-time. On the other hand, the person detector needs to be light enough that it could run in real-time on accessible machines during commercial deployment. As mentioned in many other related papers, this speed/accuracy trade-off is a common deep learning problem and is one that will be use case specific. Those who are seeking to implement our technology should choose a person detection architecture that aligns with their own hardware limitations and use case.

### C. Euclidean Distance

The Euclidean distance is a commonly used metric that utilizes fundamental principles of trigonometry to calculate the separation between two points in space. Using Euclidean distance was an obvious first step towards finding a solution social distancing problem seeing as it is trivial to find the two-dimensional distance between two points on a frame. We parted from the assumption that if the two-dimensional distance between the two points was a good predictor of their three-dimensional distance, a classifier would be easily implementable once the person bounding boxes were obtained.

To estimate the three-dimensional distance between two people in our frame, we applied the Euclidean distance formula as follows:

Dᵢⱼ=\sqrt{(Cᵢₓ−Cⱼₓ)²+(C_{iy}−C_{jy})²}

Where Cᵢₓ and C_{iy} were the x and y-coordinates of the first centroid and Cⱼₓ and C_{jy} were the x and y-coordinates of the first centroid.

One may determine that a pair of people in the image was social distancing compliant if Dᵢⱼ [symbol] ≥ [symbol] X̅ where X̅ was the average height of human bounding boxes in the frame. This average height served as a simple approximation of the 2 m (6 ft) distance that governing bodies generally regard as far enough to reduce transmission of airborne illnesses.

### D. Machine Learning Methods

An obvious problem with the Euclidean distance classification is that it ignores the fact that three-dimensional scenes lose depth information when they are saved as two-dimensional images. As such, we started looking at ways that we could have our computer vision model learn to approximate the pairs of humans that were at safe and unsafe distances in three-dimensional space. We wanted to do this approximation knowing only the locations of their bounding boxes in the frame and the dimensions of the frame itself. Subsequently, from the bounding boxes and frame dimensions we extracted more data and created a dataset of usable information to feed into our machine learning models.

### 1) Feature Engineering:

To create a more appropriate mapping of the two-dimensional image into three-dimensional space, we gathered additional information that the human eye would use when viewing a two-dimensional image to estimate the three-dimensional distance between objects. These monocular depth cues added information that complemented the Euclidean distance metric to build a more robust three-dimensional social distancing classification tool. The gathered cues included:
The difference in relative size of two objects of known, similar dimensions.
The position of objects in our field of view.
The dimensions of the objects in our field of view.

To translate these visual cues into quantifiable features, we built a Python tool to automatically extract the following from each pair of bounding boxes in an image:
The Euclidean distance between centroids of the two human bounding boxes in question.
The proportion between the 2 bounding boxes, always calculated as:

$$\frac{{A}_{smaller \text{-} bbox}}{{A}_{larger \text{-} bbox}}$$

The height and width of each bounding box.
The x and y coordinates of the centroids of each bounding box.
Features that would eventually be filtered out, including the mean height and width of all person bounding boxes in the scene and the standard deviation of those heights and widths.

Because the ranges of the collected spatial features depended on the resolution of the image, they were normalized by the width and height of the frame.

### 2) Linear Discriminant Analysis:

Linear Discriminant Analysis (LDA) is a classification technique that uses a relationship called Fisher's Linear Discriminant. This discriminant is a transformation that allows for the projection of multidimensional data onto a hyperplane that, ideally, separates the data cleanly by class. The projection seeks to minimize the variation within each class and maximize the separation between the two class means by performing calculations over the entirety of the training data. The analysis is called linear because the resulting hyperplane is a linear combination of the input features.

### 3) K-Nearest Neighbors

The intuition behind K-Nearest Neighbors (or KNN) is that every data point should share a class with the points that are the most similar to them. As such, the algorithm will predict that the class of any data point should be the same as the most common class among its K most similar (closest) neighbors. In this case, similarity is determined by a distance metric. The most commonly used distance metric is the Euclidean distance but in theory, any distance measure should work. Since the Euclidean distance is utilized for sklearn's K Neighbors Classifier, it is the distance metric is used. The choice for K is highly dependent on the problem and is the single most important parameter of the entire algorithm.

### 4) Support Vector Machines:

Like LDA, the idea behind a support vector machine (SVM) is to find a hyperplane that best separates different groups of data. Unlike LDA, however, SVM's will construct the hyperplane only from the points that are hardest to classify. These hard-to-classify points are called support vectors, hence the name. When the original data is not linearly separable, the SVM can make use of different functions to find a separating hyperplane inseparable, the SVM can make use of different functions to find a separating hyperplane in higher dimensions without explicitly transforming the data. This higher dimension calculation is referred to as ‘the kernel trick’ and is one of the most powerful characteristics of the SVM. Through hyper parameter tuning, it is possible to find the ideal degree of the polynomial with which the data should be transformed for the hyperplane to be the most effective at separation.

### 5) Logistic Regression:

Logistic Regression is a variant of linear regression that minimizes the error produced when fitting a sigmoidal function to a series of features with categorical output. The resulting model is used to predict on previously unseen data, and the regression outputs a probability value for the new data. The regression then binaries this probability according to some arbitrary threshold, usually 0.5. This means that any output greater than 0.5 will be characterized as class ‘1’ and those outputs less than 0.5 will be characterized as class ‘0’.

### 6) Random Forest:

A random forest is a machine learning strategy that uses a collection decision trees to produce a single classification result. Each tree is fit to a randomly sampled subset of the input features and will play a small role in the overall model's final decision. This random sampling with replacement is referred to as bootstrap aggregation, or bagging, and will yield a low-variance model dubbed a weak learner. When presented with new data, the individual decision trees make a prediction using only the features that they were trained on. In doing this, each weak learner “casts” a vote on what they think the overall output should be and the class with the majority vote becomes the predicted class. It is the collaboration, or ensemble, of these smaller trees that produces a larger, robust model that is both low-variance and low-bias.

### E. Performance Metrics

To compare the performance results of our three methods, we used Matthew's Correlation Coefficient (MCC). This coefficient addresses the imbalance in our dataset by using all confusion matrix elements in its calculation. It is defined by the formula:

$$MCC = \frac{TP \cdot TN - FP \cdot FN}{\sqrt{( TP + FP ) ( TP + FN ) ( TN + FP ) ( TN + FN )}}$$

Since Matthew's Correlation Coefficient is dependent on true positives, false positives, true negatives, and false negatives, it requires a high value for all four categories to approach its peak value, 1.0.

### IV. RESULTS

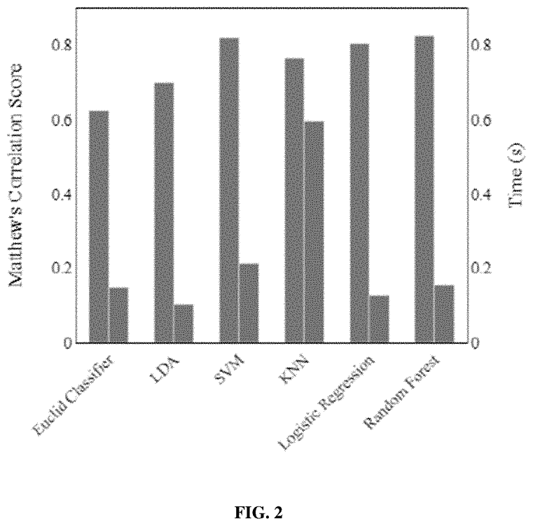

To compensate for the randomness of our parameter optimization strategy, we automated one hundred trials of tuning and inference. In this manner, we could thoroughly compare the 6 methods of classification. For every trial we recorded the MCC results and saved them to a csv file. To reinforce our testing, we also measured the time in seconds that it took for each model to perform one hundred inferences. Each inference consisted of one hundred random bounding boxes being passed through the feature engineering logic to subsequently be predicted on. We did this to test the realistic computational limits of each model. To avoid confounding of variables, the benchmark was performed on the default sclera implementations of each binary classifier. The benchmark test was performed on an Intel i7-8650U CPU with 16 GB of RAM and its results are reported in Table I and visualized in FIG. 2.

### V. DISCUSSION

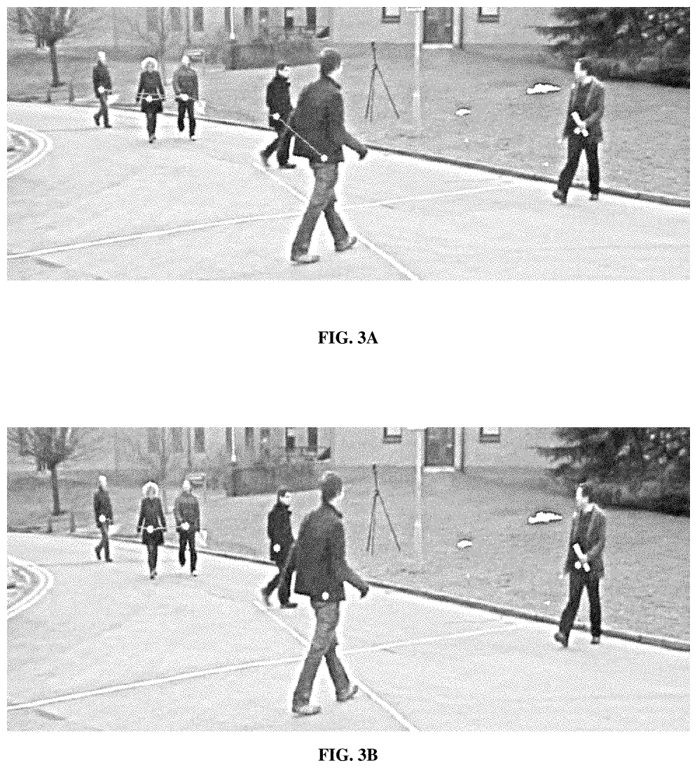

The performance of the Euclidean distance measure was hindered by its inability to generalize two-dimensional estimations of distance to a third dimension. In our testing, visual inspection revealed that the model consistently failed to recognize when two people in the same line of sight were at drastically different depths, which resulted in an increased number of false negatives. Examples of this can be seen in FIG. 3A and FIG. 3B.

FIG. 3A and 3B are diagrams illustrating examples of model outputs for a Euclidean model (FIG. 3A) and a Logistic Regression model (FIG. 3B). These annotated examples demonstrate the improvement in classification using our trained model over the baseline. Each centroid (i.e., round dot on person) is a detected person and the line connecting the centroids represents a pair of people who are not adhering to social distancing guidelines.

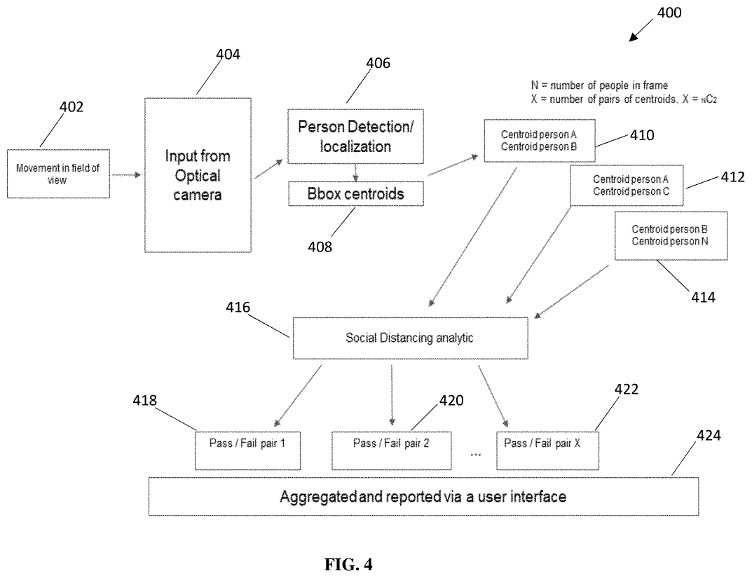

FIG. 4 is a block diagram illustrating an exemplary process or method for accurate recognition of adherence to social distancing regulations using imaging data. According to FIG. 4, system 400 start with imaging sensor (e.g., camera) detecting movement in a field of view at 402. The info is received as input from the optical camera 404.

A person detection and/or localization module 406 is used to detect bounding box (Bbox) centroids 408. Bbox or bounding box centroids 408 compares “centroid of person A to centroid of person B” at 410, “centroid of person A to centroid of person C” at 412 and “centroid of person B to centroid of person N” at 414. All this info is provided to a social distancing analytics module 416.

The social distancing analytics module 416 analyzes the data and provides a result of “pass/fail pair 1” at 418, “pass/fail pair 2” at 420 or “pass/fail pair 1” at 422. Thereafter, the data is aggregated and reported via a user interface at step 424.

While the vast majority of subjects in our test videos were not in the same line of sight, this depth of field problem is significant enough that we knew that addressing it could improve our model performance significantly. One advantage that the Euclidean classifier has is that it is a deterministic model and requires no training. For this reason, it is easily implementable after obtaining the boxes from an appropriate person detection algorithm.

Per Matthew's Correlation Coefficient, LDA was able to slightly improve on classification performance but not to the extent of other classifiers. Logistic regression and the random forests, for example, were able to greatly improve on the MCC metric while maintaining a similar inference time to LDA. KNN had the opposite problem, where it performed well based on MCC but was computationally inefficient. The performance of KNN in this case was akin to running inference on a single frame per second, which did not meet our standards of real-time performance.

Logistic regression did offer an improvement over the basic Euclidean method and after tuning, the model was capable of capturing some of the more intricate relationships between variables. Logistic regression is ultimately just a series of coefficients and bias terms, meaning that training and inference can be completed quickly with limited time and computational resources. This fact also means that the regression occupies constant space regardless of dataset size, making it one of the most portable machine learning models. The logistic regression classifier produced by our optimization strategy was able to meet our requirements for performance and size, making it the method of choice among the six explored.

In this test set, the random forest classifier was the strongest of all six methods in terms of raw classification performance. This was to be expected, as ensemble methods generally perform well since the collective variance of many predictors working together are able to compensate for the variance of each constituent decision tree. The random forest classifier is also able to prune unimportant input features, is invariant to scaling and its performance does not depend on independence among variables or their multicollinearity. This means that one can skip several assumptions that are prerequisites for other types of statistical analyses.

One of the biggest issues with random forests is that, in order to maintain performance as the dataset grows, it becomes necessary to allow the individual tree depths to grow as well. This becomes more apparent with large datasets, as the increase in tree depth and in the number of predictors makes it impractical to port the trained model to other devices, which was one of our goals.

One notable improvement that this area of research could benefit from is the collection of controlled data with real annotated distances instead of approximated data. This controlled dataset could also include different scenes, fields of view and more variation of people positions within the frame. A thoroughly curated and annotated dataset could also open the possibility for developing deep neural networks that will continuously improve with added data, unlike the classical models explored in this work. In addition, post processing techniques such as person re-identification could be used to flag on “legal” infringement such as members of the same family group, reducing the amount of unnecessary alerting. Further embodiments could be extended to leverage person tracking to create a temporal feature set that could increase accuracy.

### VI. CONCLUSION

The most important pitfall when solving the problem of social distancing is the lack of annotated data. Even a dataset with approximate annotations solves many of the problems that naive distance approaches have with depth perception. Overall, by leveraging such a dataset one may improve on the Euclidean model results and find a classifier that is suitable for commercial deployment. All the models observed had compromises, whether in terms of the size the model took to export, the classification performance, or the speed of inference. Out of all the models tried however, Logistic regression was the classifier that provided (in our view) the best accuracy-size-speed trade-off. As a result, it was the chosen model for conducting field-tests of our findings.

In testing, the method performed strongly in a variety of scenes and had the added benefit that it could run in real-time with no prior calibration. For this reason, iteration of the model could help in the fight against the pandemic and could be a stepping stone to models that solve the same problem with deep learning. While social distancing has shown to be an effective method of containing airborne illness, it is important that we leverage all tools available to carry it out effectively, including the one that we provide in this paper. In this manner, we can reduce the risks that we are all subject to and possibly help decrease the burden on the health-care services of our local communities.

Since social distancing is such a critical requirement to reducing the spread of airborne illness, it is important that distancing violations can be recognized for reporting and enforcement purposes. This work has demonstrated an effective approach to social distancing recognition by leveraging a purpose-built dataset and features that were engineered to better represent three-dimensional position from a two-dimensional (2D) image. A 20% improvement over the Euclidean model results on average and find a classifier that is suitable for deployment in a general surveillance setting. In testing, our extracted features strongly improved results in a variety of scenes and had the added benefit that it could run in real-time with no prior calibration. The logistic regression classifier had the best tradeoff of accuracy, size, and speed. As a result, it is recommended that this classifier is used alongside a purpose-built person detection algorithm for deploying a social distancing recognition system.

In further embodiments, a system for recognition of adherence to social distancing regulations in image data is disclosed. The system comprises a camera detection system to capture videos, a computer processor to process the video images, a software annotation module to analyze and annotate frames of the video images and a distance module capable of recognizing people in frames, estimating their distance and classifying compliance/non-compliance of social distancing.

According to the embodiment, the distance module is programmed to detect people that are a distance apart and estimates the distance between all pairs of people and identifies those distances that are not compliant based on a threshold. The camera detection system is a CCTV system and captures videos at variety of angles at a wide variety of distances. Further, the threshold is user-defined and the distance apart between people is tunable wherein the tunable distance apart can be set at 6 feet between people.

According to the embodiment, the system utilizes various machine learning models that that measures distance between human detection centroids in the 2-dimensional target image. The machine learning training model is selected from a list consist of consisting of Euclidean Distance, K nearest neighbours, support vector machines, logistic regression and Random Forest.

In further embodiments, a computer implemented method for recognition of adherence to social distancing regulations in image data is disclosed. The computer implemented method comprises the steps of receiving a video dataset from a camera detection system, creating a second curated annotated dataset of surveillance videos, using the second annotated dataset of videos as an input to a machine learning training model, testing the trained model on more annotated video datasets; and displaying the resulting analytics on a user interface. The machine learning training model is programmed to detect people that are a distance apart and estimates the distance between all pairs of people and identifies those distances that are not compliant based on a threshold.

Implementations disclosed herein provide systems, methods and apparatus for generating or augmenting training data sets for machine learning training. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A system for recognition of adherence to social distancing regulations in image data comprising:
a camera detection system to capture videos;
a computer processor to process the video images;
a software annotation module to analyze and annotate frames of the video images; and
a distance module capable of recognizing people in frames, estimating their distance and classifying compliance/non-compliance of social distancing;
wherein the distance module is programmed to detect people that are a distance apart and estimates the distance between all pairs of people and identifies those distances that are not compliant based on a threshold.

2. The system of claim 1 wherein the camera detection system is a CCTV system.

3. The system of claim 1 wherein the camera detection system captures videos at variety of angles at a wide variety of distances.

4. The system of claim 1 wherein the distance apart between people is tunable.

5. The system of claim 4 wherein the tunable distance apart can be set at 6 feet between people.

6. The system of claim 1 wherein the threshold is user-defined.

7. The system of claim 1 wherein the system utilizes various machine learning models that that measures distance between human detection centroids in the 2-dimensional target image.

8. The system of claim 7 wherein the machine learning training model is selected from a list consisting of Euclidean Distance, K nearest neighbours, support vector machines, logistic regression and Random Forest.

9. A computer implemented method for recognition of adherence to social distancing regulations in image data, the method comprises the steps of:
receiving a video dataset from a camera detection system;
creating a second curated annotated dataset of surveillance videos;
using the second annotated dataset of videos as an input to a machine learning training model;
testing the trained model on more annotated video datasets; and
displaying resulting analytics on a user interface;
wherein the machine learning training model is programmed to detect people that are a distance apart and estimates the distance between all pairs of people and identifies those distances that are not compliant based on a threshold.

10. The method of claim 9 wherein the camera detection system is a CCTV system.

11. The method of claim 9 wherein the camera detection system captures videos at variety of angles at a wide variety of distances.

12. The method of claim 9 wherein the distance apart between people is tunable.

13. The method of claim 12 wherein the tunable distance apart can be set at 6 feet between people.

14. The method of claim 1 wherein the threshold is user-defined.

15. The method of claim 1 wherein the system utilizes various machine learning models that that measures distance between human detection centroids in the 2-dimensional target image.

16. The method of claim 15 wherein the machine learning training model is selected from a list consisting of Euclidean Distance, K nearest neighbours, support vector machines, logistic regression and Random Forest.
